(19) United States
(12) Patent Application Publication
(10) Pub. No.: US 2014/0138258 A1
(43) Pub. Date: May 22, 2014

(54) Method for Enhancing Minerals Removal

(71) Applicant: David Sherzer, Omer (IL)

(72) Inventor: David Sherzer, Omer (IL)

(21) Appl. No.: 14/082,942

(22) Filed: Nov. 18, 2013

(30) Foreign Application Priority Data
Nov. 18, 2012 (IL) 223122

(51) Int. Cl. C02F 1/461

(52) U.S. Cl. CPC C02F 1/461
USPC 205/743; 205/742; 205/746

(57) ABSTRACT

In a water processing system including a first volume with a raw water inlet and a soft water outlet and a second volume for collecting minerals therein, and wherein mineral ions are transferred to the second volume using an electrolysis process, a method for enhancing minerals removal comprising the steps of transferring water from the second volume to a minerals removal device and using a partial electrolysis process in the minerals removal device to cause minerals to be deposited there. Preferably, the first and second volumes are separated by a membrane.

### CROSS-REFERENCE TO RELATED APPLICATIONS

The present invention claims priority from the patent application No. 223122 filed by the present applicant in Israel on 18 Nov. 2012 and entitled: “Method for Enhancing Minerals Removal”.

### STATEMENT REGARDING FEDERALLY SPONSORED RESEARCH OR DEVELOPMENT

None

### THE NAMES OF THE PARTIES TO A JOINT RESEARCH AGREEMENT

None

### BACKGROUND OF THE INVENTION

1. Field of the Invention

The present invention relates to a method for water pre-treatment for enhancing minerals removal in water processing systems.

2. Description of Related Art Including Information

The present invention generally relates to removing minerals prior to supplying water to water systems, for example in such applications as cooling towers, hot water systems and reverse osmosis (RO) systems, and others.

In prior art, treating water using partial electrolysis in a designated reactor removes a limited amount of minerals. For removing substantial amount of minerals, it is required to combine the partial electrolysis reactor with complementary technologies such as reverse osmosis.

Reverse osmosis is a process employing a high water pressure being applied on a membrane for removing minerals from the water.

A small amount of minerals remain in the product water, however most of the minerals together with water are rejected from the membrane. The amount of the reject water substantially increases the water volume entering the system.

Reject minerals remain in the water and may reduce the effectiveness of the process.

### BRIEF SUMMARY OF THE INVENTION

The present invention substantially relates to embodiments of a method for water pre-treatment for enhancing mineral removal in water processing systems.

The present invention combines a membrane and a partial electrolysis reactor in one unit, wherein water are passing through a tube covered with a membrane inserted in the partial electrolysis reactor. Hard minerals are attracted to the cathode and create a high concentration layer. This water layer is pumped to a conventional partial electrolysis reactor.

The highly concentrated stream is drawn to a separate, different reactor, wherein build-up of scale is performed much more effectively.

### BRIEF DESCRIPTION OF THE SEVERAL VIEWS OF THE DRAWINGS

FIG. 1 details a system for water pre-treatment for enhancing mineral removal in water processing systems.

FIG. 2 details a system for water pre-treatment.

### DETAILED DESCRIPTION OF THE INVENTION

The current invention will now be described by way of example and with reference to the accompanying drawings.

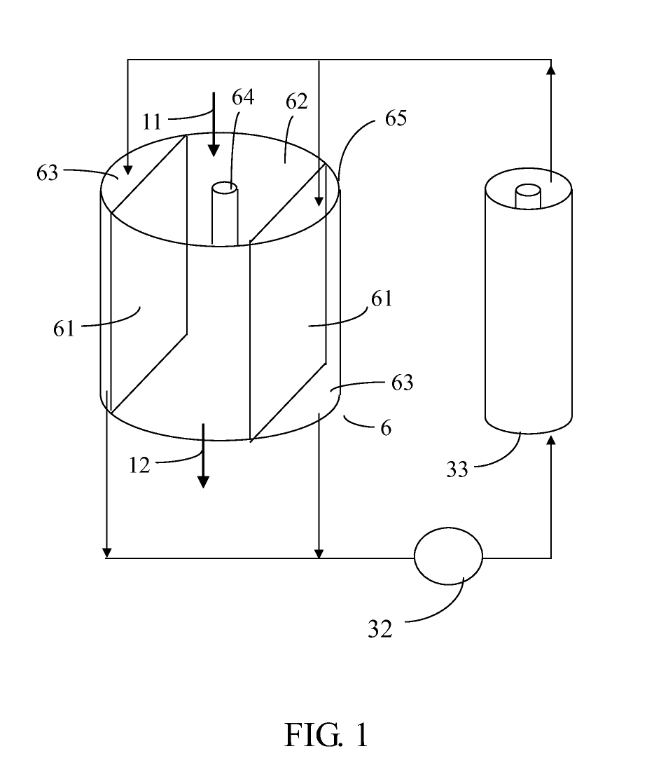

FIG. 1 details a system for water pre-treatment for enhancing mineral removal in water processing systems.

The system relates to water pre-processing in a minerals removal device 6, with a raw water inlet 11 and a soft water outlet 12 to consumers.

A membrane 61 is used in pre-processing, wherein the membrane 61 separates between a first volume 62 and a second volume 63. An electrical current flows between the anode 64 and the cathode 65.

Thus, the membrane 51 and a partial electrolysis reactor between the anode 64 and the cathode 65 are used to remove minerals from the water.

Hard minerals are attracted to the cathode 65 and pass through the membrane 61 from the volume 62 to the volume 63, to create a high minerals concentration volume 63. This water volume may be pumped to a conventional partial electrolysis reactor 33, which may be implemented using a UET reactor (TM).

A UET reactor 33 or other means are used for minerals removal from the water, in conjunction with a circulation pump 32.

The structure and operation of the ET reactor is disclosed in a co-pending patent application filed by the present applicant, and entitled:

“Method for Treating Water in Steam Boilers”.

This co-pending application, hereby included by reference, is patent application No. 223080 filed in Israel on 15 Nov. 2012.

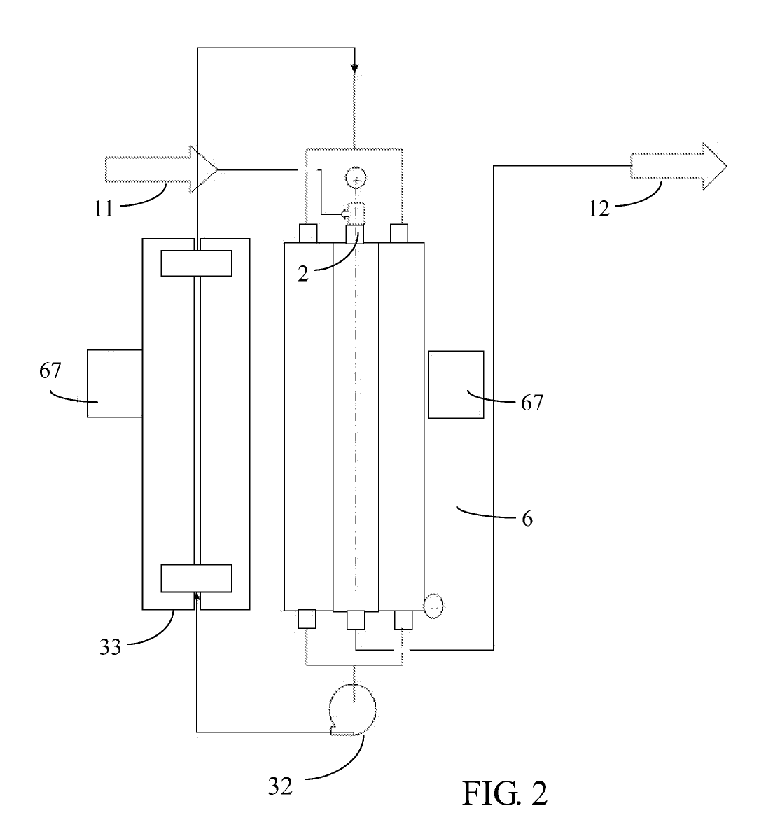

FIG. 2 details a system for water pre-treatment.

In this embodiment, the system includes a circulation pump 32, and a UET reactor 33 or other means for scale removal from water.

Minerals are removed from the water in the minerals removal device 6. The device 6 has a raw water inlet 11 and a soft water outlet 12.

An electrical current source 67 is used for minerals removal in device 6.

In a preferred embodiment, a current source of about 10 Ampere is used.

Therefore, the system implements two functional circuits:

A first circuit through the device 6, from a raw water inlet 11 to a soft water outlet 12, wherein minerals are removed from the water in the first volume 62, by passing mineral ions through the membrane 61 to a second volume 63; and

a second path for removing minerals from the second volume 62, by passing water from that volume through a minerals removal means 33 such as a UET reactor.

Furthermore, the present invention may be used in combination with another invention as disclosed in a co-pending patent application by the present applicant, and entitled:

“Method for On-Line Control of Water Treatment”.

This co-pending application, hereby included by reference, is patent application No. 223121 filed in Israel on 18 Nov. 2012.

The combination can be used to measure water characteristics in real time, in the volumes 62 and 63, and to change the electrical processing parameters in one or both of the devices 6 and 33, to improve overall system performance according to predefined criteria, as will become apparent to persons skilled in the art.

Method for Treating Water in Steam Boilers

According to one aspect of the invention, raw water is used instead of chemicals as a source for anti-corrosion inhibitors. Raw water is used in order to pre-treat only about 60% of the water. The rest, or 40% of the water, will be regular raw water leaving the Calcium in the water to be a natural corrosion inhibitor.

The excess of Calcium in the raw water that can potentially form scale will cause a scale deposit in a specifically designed reactor (the UET reactor).

Thus, scale will be deposited in the UET reactor rather than in the boiler.

It is much easier to clean scale from the UET reactor than from the boiler.

According to another feature of the present invention, scale precipitation in the UET reactor is stimulated using a partial electrolysis.

Furthermore, partial “hard” water will be introduced into the boiler; such water as can be used in the boiler feed without any need for softening the water or introducing chemicals and while ameliorating the problems of scale or corrosion problems. The water in the boiler system will remain balanced and therefore scale or corrosion problems are reduced.

This process eliminates the need for chemical introduction.

According to yet another aspect of the invention, water is recycled between the heater and the UET reactor, to accelerate the precipitation of scale, to prepare the water for use in the boiler.

Furthermore, water is recycled through the UET reactor at a faster rate (volume of water per hour) than the rate water is converted to steam in the boiler.

Method for On-Line Control of Water Treatment

The invention relates to methods for on-line, real-time measurement and control of scale buildup and water treatment in cooling towers and hot water systems, devised to replace prior art off-line control commenced by chemical analysis of the water.

In prior art system relating to hot water in its various uses such as cooling towers and heat exchangers, there is a problem to measure the scale buildup; the scale buildup affects system performance.

Furthermore, if water treatment means are used to reduce the amount of scale or scale producing agents in the water, it is required to control these treatment means responsive to actual characteristics of the water.

Moreover, it is necessary to estimate in real time when a significant amount of scale is deposited in the heat exchanger, which may require cleaning the heat exchanger.

At present, water treatment in cooling towers and hot water systems and other water systems where scale deposits in the water systems, is normally controlled by taking water samples for analysis to a laboratory, analyzing the samples in the lab and comparing the results to statistical graphs and tables based on past performance.

One limitation of such methods is that no on-line control is performed.

All the results of the water analysis are off-line and involve a significant time delay, before adjustments can be made. This may destabilize or otherwise reduce the efficiency of the closed control loop effecting the scale treatment in the system.

The existing methods may have these weak points, among others:

1. Any specific system might not behave like the statistical results gathered from various graphs and tables, which may be gathered from other systems.

2. The collection of the water analysis data might be mistaken or erroneous due to inadequate analytical methods; such mistakes or errors may lead to ineffective or even faulty control.

The invention substantially relates to embodiments of a method for on-line control of water treatment with regard to scale formation. The invention uses several well-known real-time measuring methods and combines them with a conventional control system. The treated water in the system pass through a scaled-down heat exchanger which is designed to function like the actual heat exchanger in the water system.

The scaled-down heat exchanger is heated by electricity, to simulate the water heating in the real heat exchanger.

The electrical consumption is measured by conventional analog and/or digital measuring equipment.

Once scale is built on the scaled-down heat exchanger, the consumption of electricity increases and an indicative signal will change accordingly.

This signal may activate an alert and the control systems will react accordingly.

The signal may be used in a controller to generate a control signal to be applied to the water treatment system, which will correct the water treatment parameters to adapt to actual, real-time conditions in the system.

One embodiment of the method includes the steps of:

(A) Calculating the amount of scale that can be deposited on the heat exchanger in the main system.

(B) Designing a scaled down heat exchanger where treated water will pass through it.

(C) The scaled down heat exchanger, water will be heated by electricity. The electricity consumption will be measured by adequate equipment to generate analog and/or digital indicative signals.

(D) The indicative signals will be connected to a programmable controller

(E) The indicative signals will be monitored by the programmable controller. An output from the controller will adjust the water treatment to prevent or reduce scale formation in the heat exchanger to the point that the electrical consumption will be reduced again to its desired setpoint.

It will become apparent to persons skilled in the art that the various features and methods herein presented can be used in various combinations to achieve improved performance in water processing systems and methods.

It will be recognized that the foregoing is but one example of an apparatus and method within the scope of the present invention and that various modifications will occur to those skilled in the art upon reading the disclosure set forth hereinbefore.

1. In a water processing system including a first volume with a raw water inlet and a soft water outlet and a second volume for collecting minerals therein, wherein mineral ions are transferred to the second volume using an electrolysis process, a method for enhancing minerals removal comprising the steps of transferring water from the second volume to a minerals removal device and using a partial electrolysis process in the minerals removal device to cause minerals to be deposited there.

2. The method for enhancing minerals removal according to claim 1, wherein the first and second volumes are separated by a membrane.

3. The method for enhancing minerals removal according to claim 1, wherein the minerals removal device comprises an UET reactor.

4. The method for enhancing minerals removal according to claim 1, wherein the process for enhancing minerals removal is used as a water pre-treatment in a water processing system.

5. The method for enhancing minerals removal according to claim 1, further including means for measuring water characteristics in real time and wherein parameters of the process for enhancing minerals removal are controlled responsive to the measured water characteristics.
